(19) United States
(12) Patent Application Publication
(10) Pub. No.: US 2007/0046659 A1
(43) Pub. Date: Mar. 1, 2007

(54) Drive circuit and display apparatus including the same

(75) Inventors: Takashi Iwami, Chuo-shi (JP); Tomoaki Tatsumi, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 11/498,267

(22) Filed: Aug. 3, 2006

(30) Foreign Application Priority Data
Aug. 4, 2005 (JP) 2005-226275

(51) Int. Cl. G09G 5/00

(52) U.S. Cl. 345/211

(57) ABSTRACT

Disclosed is a drive circuit that allows an improvement of driving capability of switching devices in an output circuit that drives capacitive loads, and allows an improvement in power recovery efficiency. The drive circuit comprises: a second power supply circuit for supplying a second power supply voltage; and a plurality of output control circuits each for individually controlling switching operations of a first switching transistor and a second switching transistor. The second power supply circuit superimposes a DC voltage on a first power supply voltage from an output terminal of a first power supply circuit to generate the second power supply voltage, and supplies the generated voltage to the output control circuits. The first switching transistor selectively supplies an output voltage to its corresponding capacitive load in response to the first switching control signal supplied from its corresponding output control circuit.

### BACKGROUND OF THE INVENTION

1. Field of the Invention

The present invention relates to a drive circuit for driving capacitive loads such as display cells or the like, and to a display apparatus including the same, and more particularly to a drive circuit including a power recovery circuit for recovering electrical charges from charged capacitive loads and for reusing the recovered electrical charges, and to a display apparatus including the same.

2. Description of the Related Art

Power devices such as MOSFETs (MOS field effect transistors) or IGBTs (insulated gate bipolar transistors) are widely used as switching devices for applying driving pulses to display cells of a display apparatus such as a liquid crystal display, an organic EL display, or a plasma display. For example, in the plasma display, there is formed a discharge space in which discharge gases are sealed between a front glass substrate and a rear substrate that are arranged opposite each other. On an inner surface of the front glass substrate, a plurality of row electrode pairs is formed, each of the row electrode pairs consisting of two band-shaped electrodes extending in a row direction. On an inner surface of the rear substrate, a plurality of band-shaped column electrodes is formed extending in a column direction. In the regions corresponding to respective intersections of the column electrodes with the row electrode pairs, a plurality of display cells (discharge cells) is formed in which fluorescent materials are applied to the inside of display cells, and partition the discharge space into a plurality of regions. In order to display an image on such a plasma display, a drive circuit applies address pulses of high voltage to the display cells through the column electrodes thereby to selectively generate wall charges in the display cells. Then, the drive circuit repeatedly applies sustaining discharge pulses to these display cells through the row electrode pairs. As a result, gas discharges (sustaining discharges) occur in the display cells where the wall charges have been formed. UV rays produced by the gas discharges excite the fluorescent materials in the display cells to cause the fluorescent materials to emit light. Prior art related to the plasma display described above is disclosed in, for instance, Japanese Patent Application Publication (Kokai) No. 2004-4606 (or its corresponding U.S. Patent Application Publication No. 2003/193451).

In order to reduce power consumption, many plasma displays are provided with power recovery circuits that recover electrical charges (reactive power) and reuse the recovered electrical charges. Prior art related to such power recovery circuits is disclosed in, for instance, Japanese Patent No. 2946921. FIG. 1 is a diagram schematically illustrating a partial configuration of a drive circuit 100 having a power recovery circuit as disclosed in Japanese Patent No. 2946921. This driver circuit 100 comprises a power recovery circuit 105 and an output circuit 101 that is connected to a capacitive load Cp (display cell) through an electrode.

The power recovery circuit 105 includes a p-channel type MOS transistor PR1, diodes R1, R2 and an n-channel type MOS transistor NR1 where these elements PR1, R1, R2 and NR1 are connected in series. Parasitic diodes DR1 and DR3 are formed in the p-channel type MOS transistor PR1 and the n-channel type MOS transistor NR1, respectively. A connection point between the source of the p-channel type MOS transistor PR1 and the source of the n-channel type MOS transistor NR1 is connected to one terminal of a neutral capacitor Ci, and the other terminal of the neutral capacitor Ci is connected to a ground potential. The neutral capacitor Ci is a capacitor for power recovery that has a significantly higher capacitance than that of the capacitive load Cp, and is capable of functioning as a power supply. The power recovery circuit 105 includes a p-channel type MOS transistor PR2 and an n-channel type MOS transistor NR2 that are connected in series. Parasitic diodes DR2 and DR4 are formed in the p-channel type MOS transistor PR2 and the n-channel type MOS transistor NR2, respectively. The source of the p-channel type MOS transistor PR2 is connected to a DC power supply that produces a DC voltage VDD, and the source of the n-channel type MOS transistor NR2 is connected to a ground potential. Further, one terminal of an inductor Li is connected to a connection point between the diodes R1 and R2. The other terminal is connected to the drain of the p-channel type MOS transistor PR2, to the drain of the n-channel type MOS transistor NR2, and to an I/O terminal T1. All the MOS transistors PR1, PR2, NR1 and NR2 are MOSFETs (enhancement-mode Metal-Oxide Semiconductor Field-Effect Transistors).

The output circuit 101 includes a pre-buffer circuit 102, a level converting circuit 103 and a push-pull circuit (switching circuit) 104. The level converting circuit 103 includes n-channel type MOS transistors NM1, NM2, and p-channel type MOS transistors PM1, PM2. The push-pull circuit 104 has a CMOS structure (Complementary Metal-Oxide-Semiconductor structure) and includes a p-channel type MOS transistor PM3 and an n-channel type MOS transistor NM3 that are connected in series. Parasitic diodes DO1, DO2 are formed in the MOS transistors PM3, and NM3, respectively. The source of the p-channel type MOS transistor PM3 is connected to an I/O terminal T2 that is connected to the I/O terminal T1 of the power recovery circuit 105. The source of the n-channel type MOS transistor NM3 is connected to a ground potential. The pre-buffer circuit 102 is a logic gate circuit that generates control voltages to be applied to the MOS transistors NM1, NM2 and NM3 in response to an input signal voltage V_{IN}.

Operations of the drive circuit 100 will now be described. When no pulse is applied to the capacitive load Cp, an input signal voltage V_{IN} of the logical value “0” is applied to the pre-buffer circuit 102. The pre-buffer circuit 102, in response to the input signal voltage V_{IN}, supplies a gate voltage that turns off the MOS transistor NM2, and supplies a gate voltage that turns on the MOS transistors NM1, NM3. As a result the p-channel type MOS transistor PM3 becomes non-conductive, and the n-channel type MOS transistor NM3 becomes conductive. The output voltage applied to the capacitive load Cp is accordingly set to the ground potential.

Next, when the output voltage applied to the capacitive load Cp is allowed to rise, an input signal voltage V_{IN} of the logical value “1” is applied to the pre-buffer circuit 102. The pre-buffer circuit 102, in response to the input signal voltage V_{IN}, supplies a gate voltage that turns on the MOS transistor NM2, and supplies a gate voltage that turns on the MOS transistors NM1, NM3. As a result the n-channel type MOS transistor NM3 becomes non-conductive. In this condition, as illustrated in FIG. 2, at a certain time t0 when a gate voltage is applied which causes the p-channel type MOS transistor PR1 of the power recovery circuit 105 to be turned on, the p-channel type MOS transistor PM3 is turned on and becomes conductive, whereby the inductor Li and the capacitive load Cp form an LC resonant circuit. Through operation of this LC resonant circuit, a driving current (electrical charges) is supplied from the neutral capacitor Ci to the capacitive load Cp through the MOS transistor PR1, the diode R1, the inductor Li and the p-channel type MOS transistor PM3. As a result, the level of the output voltage starts to rise from the ground potential. The output voltage is then clamped to the power supply voltage VDD at time t1 when a gate voltage is applied to turn on the p-channel type MOS transistor PR2.

When the output voltage is allowed to drop as illustrated in FIG. 2, gate voltages that causes the p-channel type MOS transistors PR1, PR2 to be turned off are applied at time t2, and a gate voltage that causes the n-channel type MOS transistor NR1 to be turned on is applied. As a result, the electrical charges accumulated in the charged capacitive load Cp are recovered into the neutral capacitor Ci through the MOS transistor PM3, the inductor Li, the diode R2 and the MOS transistor NR1, thereby allowing the capacitive load Cp to become discharged. The output voltage then starts to drop from the power supply voltage VDD. Thereafter, a gate voltage is applied then to turn on the n-channel type MOS transistor NR2 at time t3. The output voltage is then clamped to the ground potential.

In the drive circuit 100 described above, there is a problem with power recovery efficiency depending on output characteristics or driving capability of the MOS transistor PM3 on the high-voltage side of the push-pull circuit 104. In the low voltage region where the voltage applied from the power recovery circuit 105 to the push-pull circuit 104 is low, the on-resistance of the p-channel type MOS transistor PM3 is higher than in the high voltage region, thereby resulting in a lower driving current, and therefore a decrease in the power recovery efficiency. There is a further problem with enlargement of a dimension of the device region of the p-channel type MOS transistor PM3 in order to increase the driving current in the low-voltage region. This enlargement of the dimension of the device region causes a large chip size of the output circuit 101, thereby resulting in increased manufacturing cost.

Since the p-channel type MOS transistor PM3 performs a high-speed switching operation, a large amount of heat due to the on-resistance is generated. This causes a problem of an increase in manufacturing cost for a large-scale cooling mechanism.

Further, a power supply voltage from the power recovery circuit 105 is applied to the sources of the p-channel type MOS transistors PM1, PM2 of the level converting circuit 103. In the low-voltage region where the power supply voltage is low, the gate-source voltage (gate voltage) applied to the p-channel type MOS transistor PM2 is possibly less than a threshold voltage for turning on the p-channel type MOS transistor PM2. In this case, there can be a problem of lowering the power recovery efficiency due to a non-conductive state of the p-channel type MOS transistor PM3.

### SUMMARY OF THE INVENTION

In view of the foregoing, it is an object of the present invention to provide a drive circuit and a display apparatus which allow an improvement of driving capability of switching devices in an output circuit that drives capacitive loads, and particularly an improvement of driving capability of the switching devices in the low-voltage region, thereby improving power recovery efficiency.

According to one aspect of the present invention, there is provided a drive circuit for supplying output voltages to a plurality of capacitive loads in response to input logic signals, the output voltages depending on a first power supply voltage from an output terminal of a first power supply circuit. The drive circuit comprises a plurality of switching circuits each including a first switching transistor arranged on a high-voltage side thereof and a second switching transistor arranged on a low-voltage side thereof, the first switching transistor and the second switching transistor being connected in series, and a connection point between the first switching transistor and the second switching transistor being connected to a corresponding one of the capacitive loads; a second power supply circuit for supplying a second power supply voltage; and a plurality of output control circuits, each of the output control circuits, in response to a corresponding one of the input logic signals, supplying a first switching control signal depending on the second power supply voltage to the first switching transistor, and supplying a second switching control signal to the second switching transistor, thereby to individually control switching operations of the first switching transistor and the second switching transistor. The second power supply circuit superimposes a DC voltage on the first power supply voltage to generate the second power supply voltage. The first switching transistor selectively supplies an output voltage to the corresponding one of the capacitive loads through the connection point in response to the first switching control signal.

According to another aspect of the present invention, there is provided a display apparatus comprising: a plurality of display cells arranged as a two-dimensional array; a plurality of electrodes connected to the plurality of display cells; and a drive circuit for supplying output voltages to a plurality of capacitive loads through the plurality of electrodes in response to input logic signals, the output voltages depending on a first power supply voltage from an output terminal of a first power supply circuit. The drive circuit includes: a plurality of switching circuits each having a first switching transistor arranged on a high-voltage side thereof and a second switching transistor arranged on a low-voltage side thereof, the first switching transistor and the second switching transistor being connected in series, and a connection point between the first switching transistor and the second switching transistor being connected to a corresponding one of the capacitive loads; a second power supply circuit for supplying a second power supply voltage; and a plurality of output control circuits, each of the output control circuits, in response to a corresponding one of the input logic signals, supplying a first switching control signal depending on the second power supply voltage to the first switching transistor, and supplying a second switching control signal to the second switching transistor, thereby to individually control switching operations of the first switching transistor and the second switching transistor. The second power supply circuit superimposes a DC voltage on the first power supply voltage to generate the second power supply voltage. The first switching transistor selectively supplies an output voltage to the corresponding one of the capacitive loads through the connection point in response to the first switching control signal.

Further features of the invention, its nature and various advantages will be more apparent from the accompanying drawings and the following detailed description of the preferred embodiments.

### BRIEF DESCRIPTION OF THE DRAWINGS

FIG. 1 is a diagram schematically illustrating a partial configuration of a conventional drive circuit;

FIG. 2 is a timing chart illustrating signal waveforms generated in a drive circuit shown in FIG. 1;

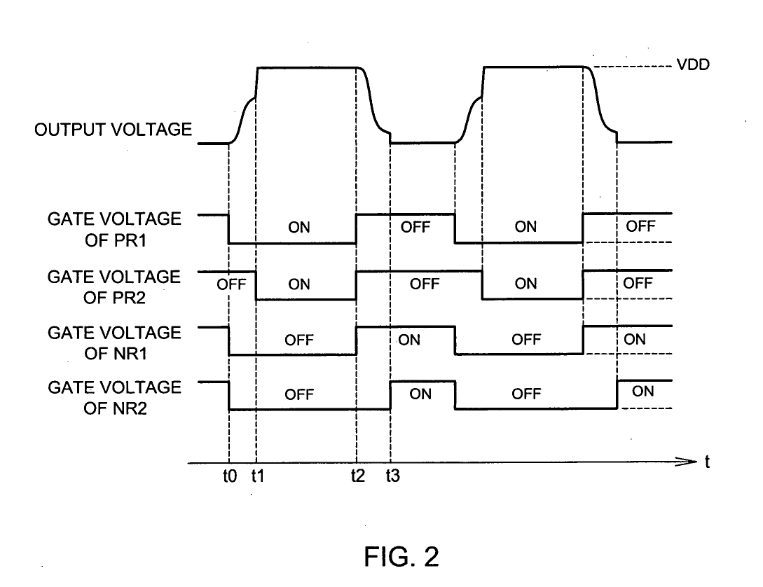

FIG. 3 is a block diagram schematically illustrating a configuration of a display apparatus (plasma display) which is one embodiment of the present invention;

FIG. 4 schematically illustrates a configuration of a column electrode driver (address driver);

FIG. 5 schematically illustrates a configuration of a drive circuit according to a first embodiment of the present invention;

FIG. 6 schematically illustrates an example of a drive sequence;

FIG. 7 is a timing chart illustrating signal waveforms generated in the drive circuit shown in FIG. 5;

FIG. 8 is a graphical representation illustrating voltage dependences of driving capabilities of MOS transistors;

FIG. 9 schematically illustrates a configuration of a modification of the first embodiment;

FIG. 10 schematically illustrates a configuration of a drive circuit according to a second embodiment of the present invention;

FIG. 11 schematically illustrates a configuration of a drive circuit according to a third embodiment of the present invention;

FIG. 12 schematically illustrates a configuration of a drive circuit according to a fourth embodiment of the present invention;

FIG. 13 schematically illustrates a configuration of a drive circuit according to a fifth embodiment of the present invention;

FIG. 14 schematically illustrates a configuration of a modification of the fifth embodiment;

FIG. 15 schematically illustrates a configuration of another modification of the fifth embodiment;

FIG. 16 schematically illustrates an exemplary configuration of a drive circuit according to a sixth embodiment of the present invention;

FIG. 17 schematically illustrates another exemplary configuration of a drive circuit according to the sixth embodiment of the present invention;

FIG. 18 schematically illustrates still another exemplary configuration of a drive circuit according to the sixth embodiment of the present invention; and

FIG. 19 schematically illustrates a configuration of a drive circuit according to a seventh embodiment of the present invention.

### DETAILED DESCRIPTION OF THE PREFERRED EMBODIMENTS

Various embodiments of the present invention will now be described with reference to the drawings.

### 1. First Embodiment

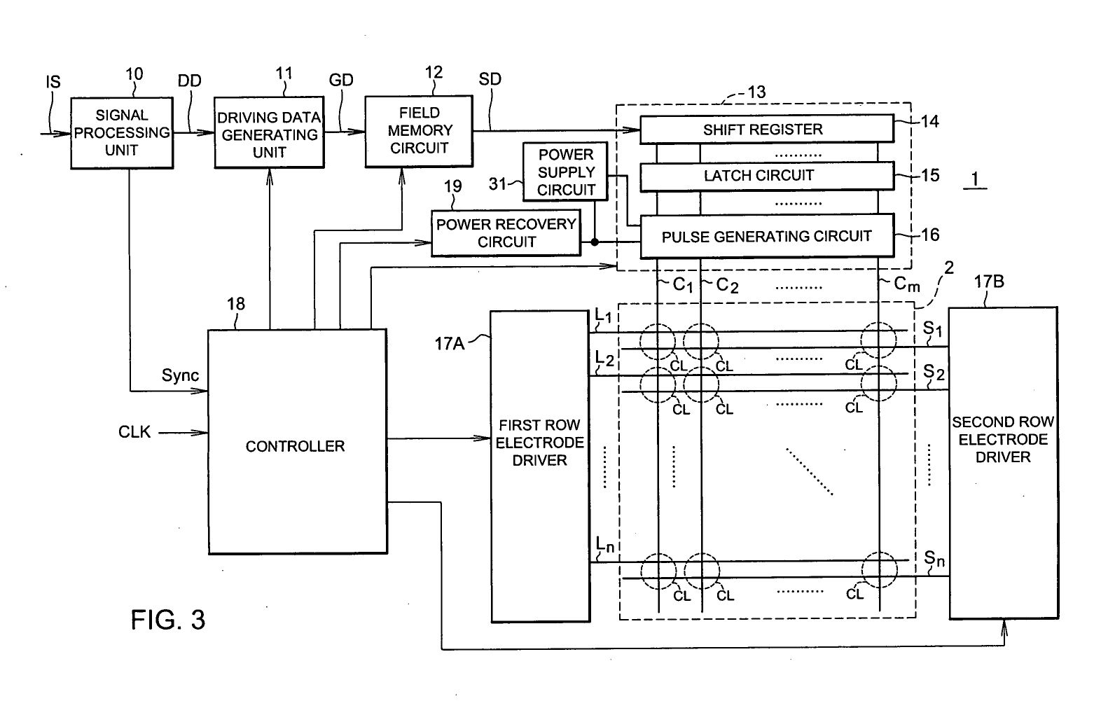

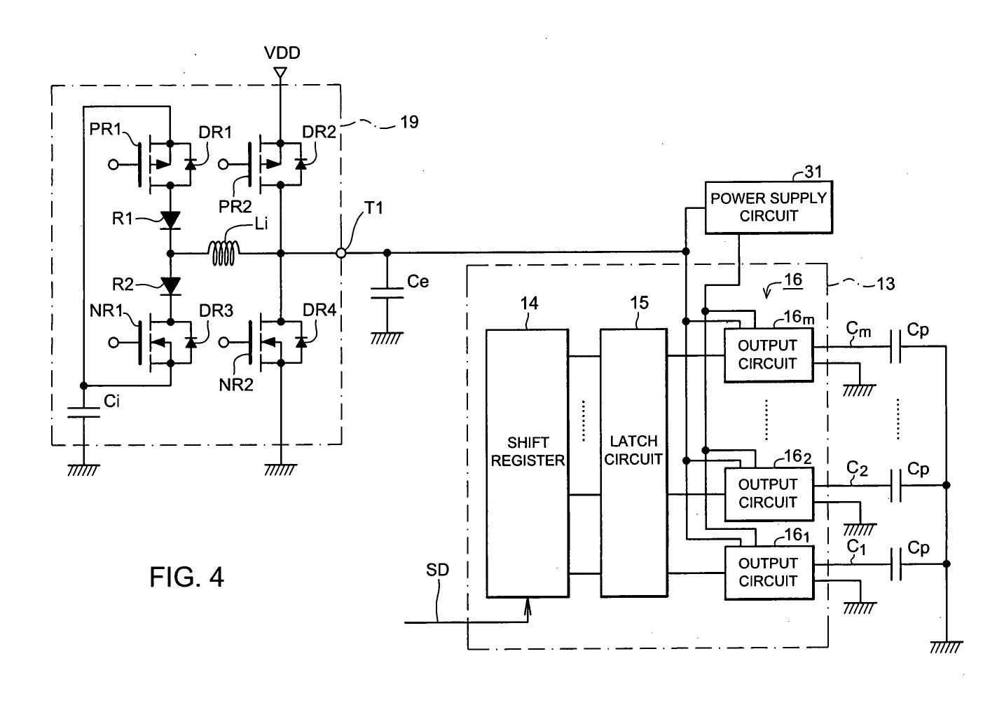

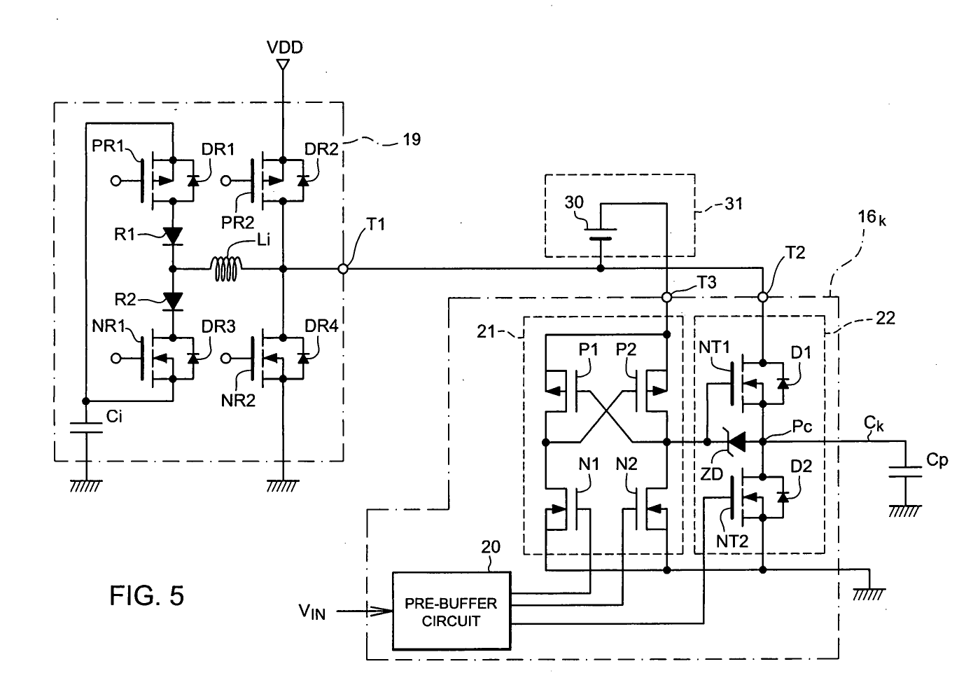

FIG. 3 is a block diagram schematically illustrating a configuration of a display apparatus (plasma display) 1 which is one embodiment of the present invention; FIG. 4 schematically illustrates a configuration of a column electrode driver (address driver) 13; and FIG. 5 schematically illustrates a configuration of an example of an output circuit constituting a pulse generating circuit 16.

As illustrated in FIG. 3, the display apparatus 1 comprises a signal processing unit 10, a driving data generating unit 11, a field memory circuit 12, a column electrode driver 13, a first row electrode driver 17A, a second row electrode driver 17B, a power recovery circuit 19, a power supply circuit 31 and a controller 18. Using a synchronization signal Sync (containing a horizontal synchronization signal and a vertical synchronization signal) and a clock signal CLK, the controller 18 generates and supplies control signals for controlling operations of the processing blocks 11, 12, 13, 17A, 17B and 19.

The display apparatus 1 comprises a display area 2 including a plurality of display cells CL arranged in a matrix of rows and columns and in a two-dimensional array. In this display area 2, n row electrodes L1, . . . , Ln (n is an integer equal to 2 or greater) are formed extending horizontally from the first electrode driver 17A; and n row electrodes S1, . . . , Sn extending horizontally from the second electrode driver 17B that is arranged facing the first electrode driver 17A through the display area 2. Two row electrodes Lq, Sq (where q is an integer from 1 to n) form one electrode pair, and one horizontal display line is formed along each electrode pair. Also, m columns electrodes C₁, . . . , Cₘ (where m is an integer equal to 2 or greater) are formed extending vertically from the column electrode driver 13. A column electrode Cₚ (where p is an integer from 1 to m) is separated from a row electrode pair Lq, Sq in the thickness direction of a substrate (not shown). Display cells CL are formed in respective regions corresponding to intersections of the column electrodes Cₚ (where p is an integer from 1 to m) with the row electrode pairs Lq, Sq. Each display cell CL includes a discharge space between the column electrodes Dₚ and the row electrode pairs Lq, Sq. In the each discharge space, fluorescent material with any one color of emission colors R (red), G (green) and B (blue) is applied.

The signal processing unit 10 performs image processing upon an input video signal IS to generate a synchronization signal Sync and a digital image signal DD, supplies the generated synchronization signal Sync to the controller 18, and supplies the generated digital image signal DD to the driving data generating unit 11. The driving data generating unit 11 converts the digital image signal DD into a driving data signal GD with a predetermined format, and supplies the driving data signal GD to the field memory circuit 12. The field memory circuit 12 temporarily stores the driving data signal GD in an internal buffer memory (not shown). The field memory circuit 12 sequentially reads subfield signals SD from the buffer memory on a subfield-by-subfield basis, and sequentially transfers the signals SD to the column electrode driver 13.

The column electrode driver 13 includes an m-bit shift register 14, a latch circuit 15 and a pulse generating circuit 16 which are operated in accordance with clocks and control signals supplied from the controller 18. The pulse generating circuit 16 is connected to a power recovery circuit 19 that operates in accordance with control signals from the controller 18. The shift register 14 samples the transferred subfield signals SD on the pulse edge of a shift clock, and shifts the sampled subfield signals SD. The shift register 14 outputs the signals in parallel on a per horizontal-line basis to the latch circuit 15. The latch circuit 15 latches the output signals from the shift register 14 and supplies the latched signals in parallel to the pulse generating circuit 16. On the basis of the output signals from the latch circuit 15, the pulse generating circuit 16 generates driving pulses such as address pulses and others, and supplies the driving pulses to the respective display cells CL through the column electrodes C₁, . . . , Cₘ. Configurations of the pulse generating circuit 16 and the power recovery circuit 19 are described below.

The first row electrode driver 17A includes a drive circuit that generates scanning pulses in synchronization with address pulses; and a drive circuit that generates discharge sustaining pulses. The second row electrode driver 17B is a drive circuit that generates discharge sustaining pulses.

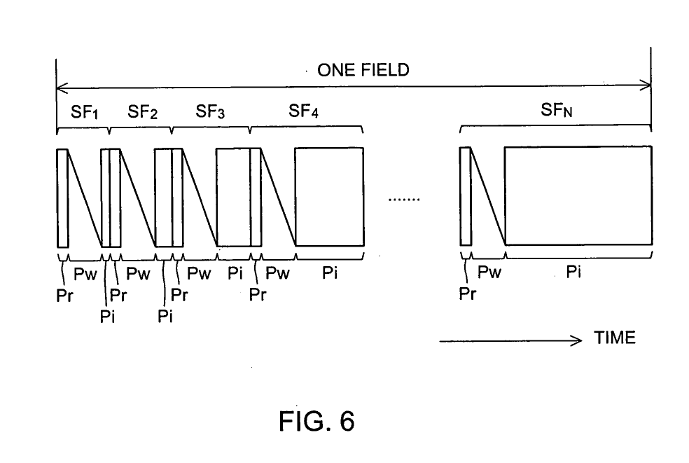

The controller 18 can control operations of the drivers 13, 17A and 17B in accordance with a predetermined drive sequence. FIG. 6 schematically illustrates an example of such a drive sequence. With reference to FIG. 6, a display period for one field represented by display data is comprised of periods of M subfield SF₁ to SF_{M} (where M is an integer equal to 2 or greater) that are arranged consecutively in the order of display, each of the subfields SF₁ to SF_{M} having a reset period Pr, an address period Pw and a sustaining period Pi. To the subfields SF₁, SF₂, SF₃, . . . , SF_{M}, emission sustaining periods Pi, Pi, Pi, . . . , Pi proportional to respective weights 2⁰, 2¹, 2², . . . , 2^{M} are assigned.

In the reset period Pr of the subfield SF₁, reset discharges are carried out in all the display cells CL to erase the wall charges inside all the display cells CL and thereby to initialize all the display cells CL. In the subsequent address period Pw, the first row electrode driver 17A sequentially applies scanning pulses to the row electrodes L1, . . . , Ln, while the column electrode driver 13 applies address pulses to the address electrodes C₁, . . . , Cₘ in synchronization with the scanning pulses. As a result, address discharges (i.e., writing address discharges) selectively occur in the display cells CL thereby to selectively form wall charges. In the sustaining period Pi, the first row electrode driver 17A and the second row electrode driver 17B repeatedly apply discharge sustaining pulses of mutually different polarities to the sustain electrodes L1, . . . , Ln and the sustain electrodes S1, . . . , Sn, respectively, for an assigned number of times. As a result, sustaining discharges repeatedly occur in the discharge cells CL where the wall charges are accumulated, thereby exciting the fluorescent material or phosphor in the display cells CL to cause light emission. In each of the subsequent subfields SF₁ to SF_{M}, the display cells CL are initialized in the reset period Pr, and then in the address period Pw, address discharges (writing address discharges) selectively take place in the display cells CL to selectively form wall charges. In the sustaining period Pi, sustaining discharges repeatedly occur, for the number of times assigned to the corresponding subfield, in the display cells CL where the wall charges are accumulated. Thus, images with 2^{M} grayscale levels can be displayed as a result of the above drive sequence.

The drive sequence is not limited to that one illustrated in FIG. 6. Alternatively, other conventional drive sequences can be used, for example the drive sequences disclosed in Japanese Patent Application Publication (Kokai) No. 2000-227778 and its based-on U.S. Patent Application Publication No. 2002-054000 (or U.S. Pat. No. 6,614,413) which are hereby incorporated by reference.

Next, the configuration of the column electrode driver 13 will be described with reference to FIGS. 4 and 5. As illustrated in FIG. 4, the pulse generating circuit 16 includes output circuits 16₁, . . . , 16ₘ that are connected to the respective column electrodes C₁, . . . , Cₘ. These output circuits 16₁, . . . , 16ₘ are connected to respective capacitive loads Cp, . . . , Cp through the respective column electrodes C₁, . . . , Cₘ. The output circuits 16₁, . . . , 16ₘ, in response to signal voltages outputted in parallel by the latch circuit 15, generate driving pulses such as address pulses and others. The output circuits 16₁, . . . , 16ₘ are connected to the power recovery circuit 19 through an electrical interconnection having a capacitor Ce between terminals T1, T2.

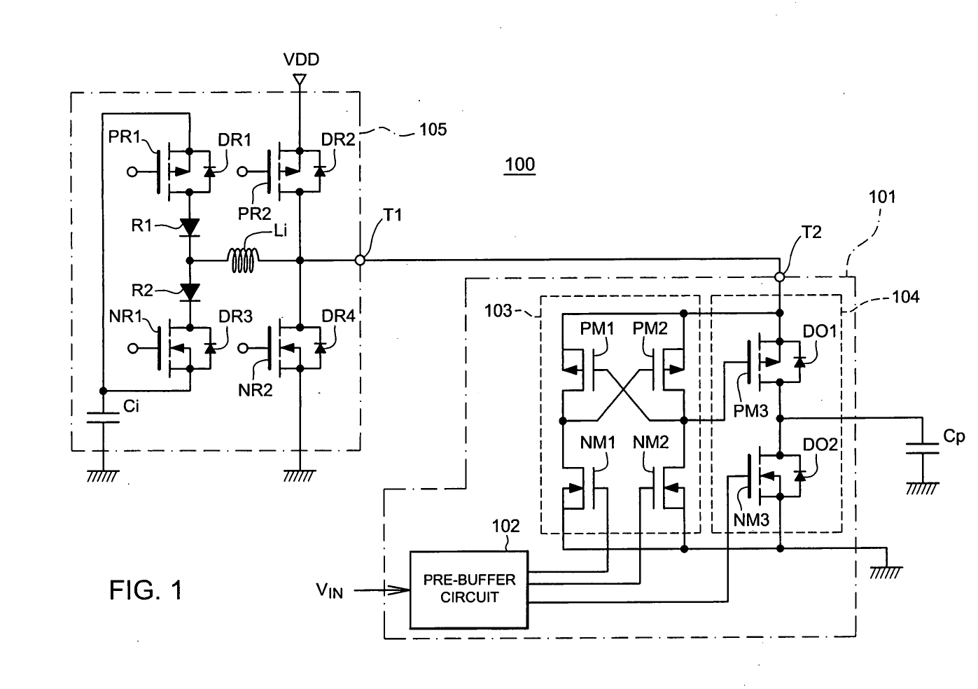

The power recovery circuit 19 has substantially the same configuration as the power recovery circuit 105 illustrated in FIG. 1. Since identical elements in FIGS. 1 and 4 are referred to by the same reference numerals, the detailed descriptions will be omitted. The configuration of the power recovery circuit 19 is not limited to the one illustrated in FIG. 4.

With reference to FIG. 5, an output circuit 16ₖ (wherein k is an integer from 1 to m) includes a pre-buffer circuit 20, a level converting circuit 21 and a totem-pole circuit (switching circuit) 22. An output control circuit according to the present invention can be constituted by the pre-buffer circuit 20 and the level converting circuit 21. The level converting circuit 21 includes a first CMOS circuit (complementary MOS circuit) having an n-channel type MOS transistor N1 and a p-channel type MOS transistor P1 that are connected in series; and a second CMOS circuit having a p-channel type MOS transistor P2 (third switching transistor) and an n-channel type MOS transistor N2 (fourth switching transistor) that are connected in series. The sources (controlled electrodes) of the p-channel type MOS transistors P1, P2 are both connected to a power supply circuit 31 that is a high-voltage power supply. The sources (controlled electrodes) of the n-channel type MOS transistors N1, N2 are both connected to a reference potential, i.e., a ground potential. The gate (controlling electrode) of the first p-channel type MOS transistor P1 is connected to the drain (controlled electrode) of the second p-channel type MOS transistor P2 and to the drain (controlled electrode) of the n-channel type MOS transistor N2, while the gate (controlling electrode) of the first p-channel type MOS transistor P2 is connected to the drain (controlled electrode) of the p-channel type MOS transistor P1 and to the drain (controlled electrode) of the n-channel type MOS transistor N1.

The power supply circuit 31 superimposes a DC voltage on the power supply voltage from the I/O terminal T1 of the power recovery circuit 19, and supplies the superimposed voltage to the sources of the MOS transistors P1, P2 of the level converting circuit 21 through the terminal T3. The superimposed voltage is generated so as to be higher than the power supply voltage from the terminal T1. In other words, the power supply circuit 31 supplies, to the source of the p-channel type MOS transistor P2, a voltage that is obtained by boosting the power supply voltage from the output terminal T1. As illustrated in FIG. 6, the power supply circuit 31 includes a voltage-boosting power supply 30 that boosts the power supply voltage from the power recovery circuit 19.

The totem-pole circuit 22 includes a high-voltage power n-channel type MOS field effect transistor (first switching transistor) NT1 provided on the high-voltage side; a constant-voltage diode ZD connected between the source and gate of the n-channel type MOS field effect transistor NT1; and a high-voltage power n-channel type MOS field effect transistor (second switching transistor) NT2 provided on the low-voltage side. Parasitic diodes D1 and D2 are formed in the MOS transistors NT1, NT2, respectively. Such the totem-pole circuit 22 has a totem-pole structure in which the n-channel type MOS transistors NT1, NT2 that are switching transistors of the same-conductivity type are connected in series.

A capacitive load Cp is connected to the connection point Pc between the high-voltage power MOS transistors NT1, NT2 through a column electrode Ck. The source (controlled electrode) of the MOS transistor NT2 arranged on the low-voltage side of the totem-pole circuit 22 is connected to a reference potential, i.e., a ground potential. The drain (controlled electrode) of the MOS transistor NT1 arranged on the high-voltage side is connected to the power recovery circuit 19 that can operate as a high-voltage power supply. Both MOS transistors NT1, NT2 are enhancement-type MOSFET transistors.

The constant-voltage diode ZD, composed of a Zener diode, for example, is a protective diode that prevents an excess voltage from being applied to the gate of the n-channel type MOS transistor NT1. The anode of the constant-voltage diode ZD is connected to the source (controlled electrode) of the n-channel type MOS transistor NT1, while the cathode is connected to the gate (controlling electrode) of the n-channel type MOS transistor NT1.

The pre-buffer circuit 20 is a logic gate circuit that, in response to the input signal voltage (logic signal voltage) V_{IN} from the latch circuit 15, generates a control voltage (switching control voltage) to be applied to the gates of the n-channel type MOS transistors N1, N2 and of the high-voltage power MOS transistor NT2.

The MOS transistors NT1, NT2 of the totem-pole circuit 22 are preferably both n-channel type MOSFET transistors as illustrated in FIG. 5, no limitation thereto intended. For example, the transistor NT1 on the high-voltage side alone may be replaced by an n-channel type IGBT that becomes conductive in response to a control voltage applied between the gate and emitter thereof. Alternatively, both the transistor NT1 on the high-voltage side and the transistor NT2 on the low-voltage side may be replaced by IGBTs. Additionally, instead of the MOS transistors NT1, NT2, npn-type bipolar transistors may be used as current-operated switching devices that become conductive in response to current signals between the base and emitter thereof.

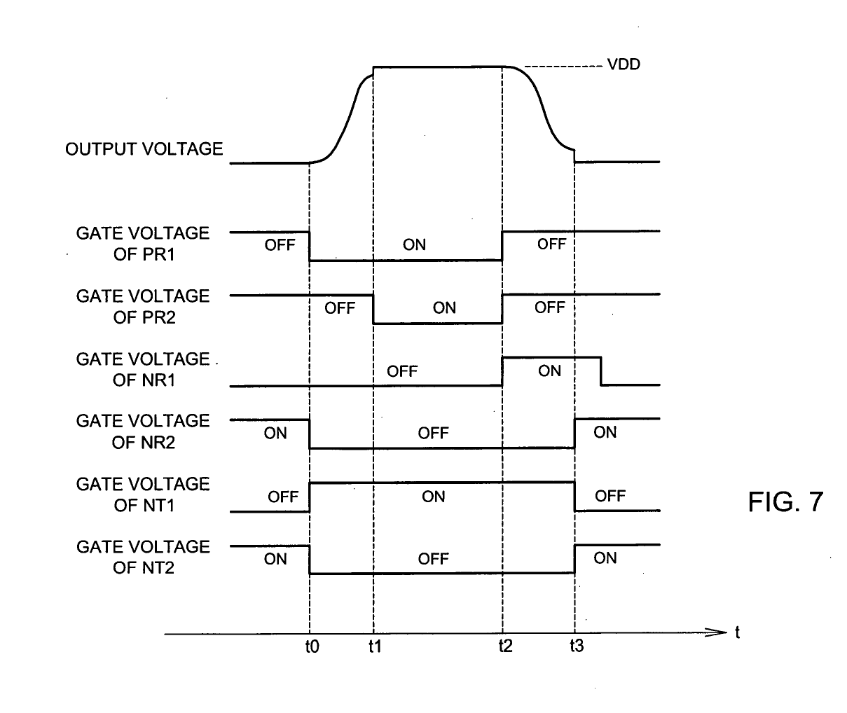

The operation of the output circuit 16ₖ will be explained next with reference to FIG. 7. FIG. 7 is a timing chart illustrating waveforms of gate voltages applied to MOS transistors in both the power recovery circuit 19 and the output circuit 16ₖ, and a waveform of the output voltage of the capacitive load Cp. When no driving pulse is applied to the capacitive load Cp (before time t0), in the power recovery circuit 19, gate voltages are supplied for turning on the n-channel type MOS transistor NR2 and for turning off the other MOS transistors PR1, PR2, NR1. In response to the input signal voltage V_{IN} of the logical value “0”, the pre-buffer circuit 20 supplies a gate voltage for turning on the n-channel type MOS transistor NT2, and supplies gate voltages for turning off the n-channel type MOS transistor N1 and for turning on the n-channel type MOS transistor N2. As a result, the n-channel type MOS transistor NT1 on the high-voltage side is non-conductive and the n-channel type MOS transistor NT2 on the low-voltage side becomes conductive, so that the output voltage applied to the capacitive load Cp becomes equal to a reference potential V_{SS}.

Next, when the output voltage applied to the capacitive load Cp is allowed to rise (at time t0), in the power recovery circuit 19, gate voltages are applied for turning the n-channel type MOS transistor NR2 from on to off, and for turning on the p-channel type MOS transistor PR1. Meanwhile, in response to a change of the input signal voltage V_{IN} from the logical value “0” to “1”, the pre-buffer circuit 20 supplies gate voltages for turning on the n-channel type MOS transistor N1, for turning off the n-channel type MOS transistor N2, and for turning off the n-channel type MOS transistor NT2. As a result, a high voltage supplied by the power supply circuit 31 through the conductive p-channel type MOS transistor P2 is applied to the gate of the n-channel type MOS transistor NT1. In other words, the high voltage is supplied to the gate of the n-channel type MOS transistor NT1 through the connection point of the p-channel type MOS transistor (third switching transistor) P2 and the n-channel type MOS transistor (fourth switching transistor) N2. The high voltage supplied by the power supply circuit 31 has preferably a voltage value within the range of control voltages that allow the n-channel type MOS transistor NT1 to be turned on without fail, that is, a voltage equal to or greater than the threshold voltage of the MOS transistor NT1. Thus, the n-channel type MOS transistor NT1 on the high-voltage side is turned on and becomes conductive, thereby allowing the capacitive load Cp and the inductor Li of the power recovery circuit 19 to form an LC resonant circuit. Through an operation of the LC resonant circuit, a driving current (electrical charges) is supplied from the neutral capacitor Ci to the capacitive load Cp through the p-channel type MOS transistor PR1, the diode R1, the inductor Li and the n-channel type MOS transistor NT1. As a result, the level of the output voltage starts to rise from the reference potential V_{SS}. Thereafter, the output voltage is clamped to the power supply voltage VDD at time t1 when a gate voltage is applied for turning the p-channel type MOS transistor PR2 from off to on.

Additionally, in order to cause the p-channel type MOS transistor P2 to become conductive without fail, the high voltage supplied by the power supply circuit 31 is preferably equal to or higher than the threshold voltage of the MOS transistor P2. When a ground potential is applied to the gate of the p-channel type MOS transistor P2, if a voltage equal to or higher than the threshold voltage Vth of the p-channel type MOS transistor P2 is applied to the source of the MOS transistor P2, the control voltage (gate-source voltage) applied to the MOS transistor P2 becomes lower than the threshold voltage Vth, and hence the MOS transistor P2 is turned on without fail.

Next, when the output voltage is allowed to drop (at time t2), in the power recovery circuit 19, gate voltages are applied for turning the p-channel type MOS transistors PR1, PR2 from on to off and for turning the n-channel type MOS transistor NR1 from off to on. As a result, the electrical charges accumulated in the charged capacitive load Cp is recovered into the neutral capacitor Ci through the n-channel type MOS transistor NT1, the inductor Li, the diode R2 and the n-channel type MOS transistor NR1. The capacitive load Cp is then discharged, and the output voltage level starts to drop from the power supply voltage VDD. Thereafter, at time t3, a gate voltage is supplied for turning the n-channel type MOS transistor NR2 of the power recovery circuit 19 from off to on, and the pre-buffer circuit 20 applies a gate voltage for turning the n-channel type MOS transistor NT2 from off to on. The output voltage then becomes clamped to the reference voltage V_{SS}.

As described above, the display apparatus 1 of the present embodiment comprises, as separated components, a power supply (power recovery circuit) 19 that supplies a power supply voltage to the totem-pole circuit 22; and the power supply (power supply circuit) 31 that supplies a power supply voltage to the level converting circuit 21. The power supply circuit 31 superimposes the power supply voltage of the power supply 30 on the power supply voltage supplied by the power recovery circuit 19, and supplies the superimposed voltage to the p-channel type MOS transistor P2 through the terminal T3. Accordingly, it is possible to turn on the p-channel type MOS transistor P2 without fail even in the low-voltage region where the power supply voltage applied to the totem-pole circuit 22 is low, thereby to allow improvement of power recovery efficiency. In particular, the power supply voltage supplied by the power supply circuit 31 is equal to or higher than the threshold voltage Vth of the MOS transistor P2, thereby allowing the p-channel type MOS transistor P2 to become conductive more without fail.

In the foregoing description, the conventional power circuit 101 illustrated in FIG. 1 uses the p-channel type MOS transistor PM3. In the low-voltage region where a low voltage is applied to the source of the p-channel type MOS transistor PM3, the on-resistance of the p-channel type MOS transistor PM3 is high and causes low driving current between the source and drain, thereby resulting in a decrease in the power recovery efficiency. On the other hand, the output circuit ¹⁶k of the present embodiment uses an n-channel type MOS transistor NT1 having a conductivity type opposite to that of a p-channel type MOS transistor. Thus, even in the low-voltage region when the output voltage rises or falls, the n-channel type MOS transistor PM3 can have a relatively low on-resistance and can exhibit high driving capability. In other words, there is an advantage in that the voltage dependence of the driving capability of the n-channel type MOS transistor NT1 is lower than the voltage dependence of the driving capability of the p-channel type MOS transistor PM3. Therefore, as compared to prior arts, the first embodiment allows simplification of a cooling mechanism because heat generated due to the on-resistance can be decreased. The first embodiment further allows sufficient large driving current in the low-voltage region without increasing the chip size, thereby allowing a reduction in manufacturing cost.

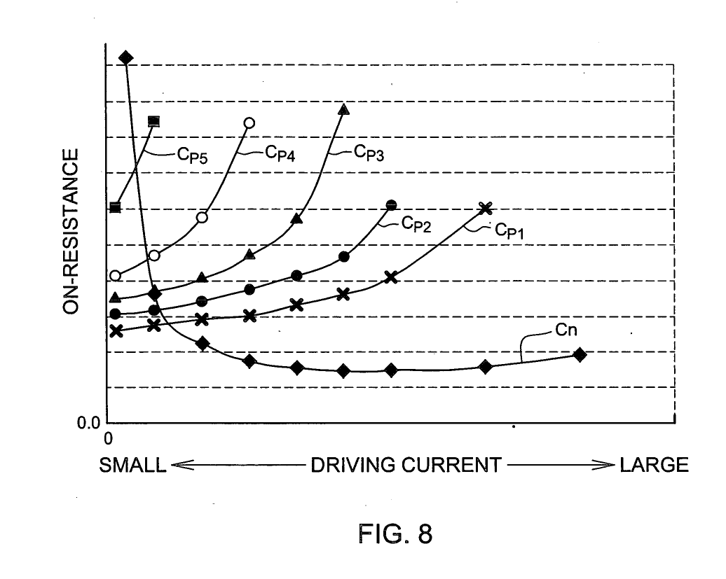

FIG. 8 is a graphical representation illustrating voltage dependences of the driving capability of the p-channel type MOS transistor PM3 (FIG. 1) and voltage dependences of the driving capability of the n-channel type MOS transistor NT1 (FIG. 5). The horizontal axis of the graph represents measured values of the driving current between the source and drain, and the vertical axis represents measured values of the on-resistance. The curves C_{P1}, C_{P2}, C_{P3}, C_{P4}, C_{P5} appearing in the graph are characteristic curves of the p-channel type MOS transistor PM3. The curves C_{P1}, C_{P2}, C_{P3}, C_{P4}, C_{P5} were measured under the conditions of constant power supply voltages V1, V2, V3, V4, V5 (where V1>V2>V3>V4>V5), respectively. The values V1 through V5 are not specifically described, and in the range from about 0 to several tens of millivolts. According these curves C_{P1} through C_{P5}, it is clear that, as the power supply voltage becomes lower, the characteristic curves shift towards the left of the graph where the driving current gets smaller and the on-resistance becomes higher. For comparison, the curve Cn representing a characteristic curve for the n-channel type MOS transistor NT1 was measured under the condition of power supply voltages within the range of V1 through V5. The characteristic curve Cn does not vary even when the power supply voltage changes from V1 to V5, and exhibits low on-resistance across a wide voltage range. Therefore, the graph of FIG. 8 shows that the voltage dependence of driving capability of the n-channel type MOS transistor NT1 is lower than that of the p-channel type MOS transistor PM3.

With reference to the graph of FIG. 8, the characteristic curve Cn shows an on-resistance that increases exponentially in the low-current region where the driving current is very small and where the n-channel type MOS transistor NT1 presents a high-impedance. The Power recovery efficiency decreases due to this low-current region. The power supply circuit 31 of the present embodiment can supply, to the n-channel type MOS transistor NT1, a power supply voltage higher than the power supply voltage supplied by the power recovery circuit 19, through the terminal T3 and the p-channel type MOS transistor P2. The gate voltage (gate-source voltage) of the n-channel type MOS transistor NT1 increases accordingly, thereby allowing shortening of the period in which the MOS transistor NT1 is in a high-impedance state. Therefore, an improvement of the power recovery efficiency can be achieved.

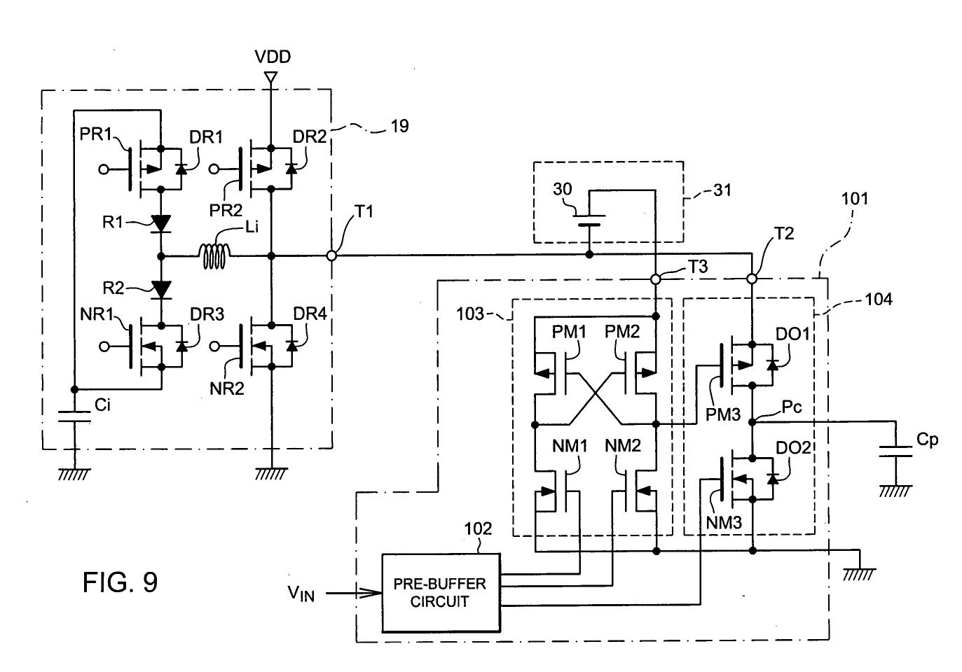

Additionally, as illustrated in FIG. 9, the conventional drive circuit 100 illustrated in FIG. 1 can be applied to the power supply circuit 31 of the first embodiment. The power supply circuit 31 shown in FIG. 9 supplies a power supply voltage to the p-channel type MOS transistors PM1, PM2 through the terminal T3. A power supply voltage inputted through the terminal T2 is not supplied to the level converting circuit 103. The drive circuit of FIG. 9 also comprises, as separated components, a power supply (power recovery circuit) 105 that applies a power supply voltage to the push-pull circuit 104; and a power supply (power supply circuit) 31 that applies a power supply voltage to the level converting circuit 103. The power supply voltage 31 can supply, to the p-channel type MOS transistor PM2 through the terminal T3, a power supply voltage higher than the power supply voltage supplied by the power recovery circuit 19. Accordingly, it is possible to turn on the p-channel type MOS transistor PM2 without fail even in the low-voltage region where the power supply voltage applied to the push-pull circuit 104 is low, thus allowing an improvement of the power recovery efficiency.

### 2. Second Embodiment

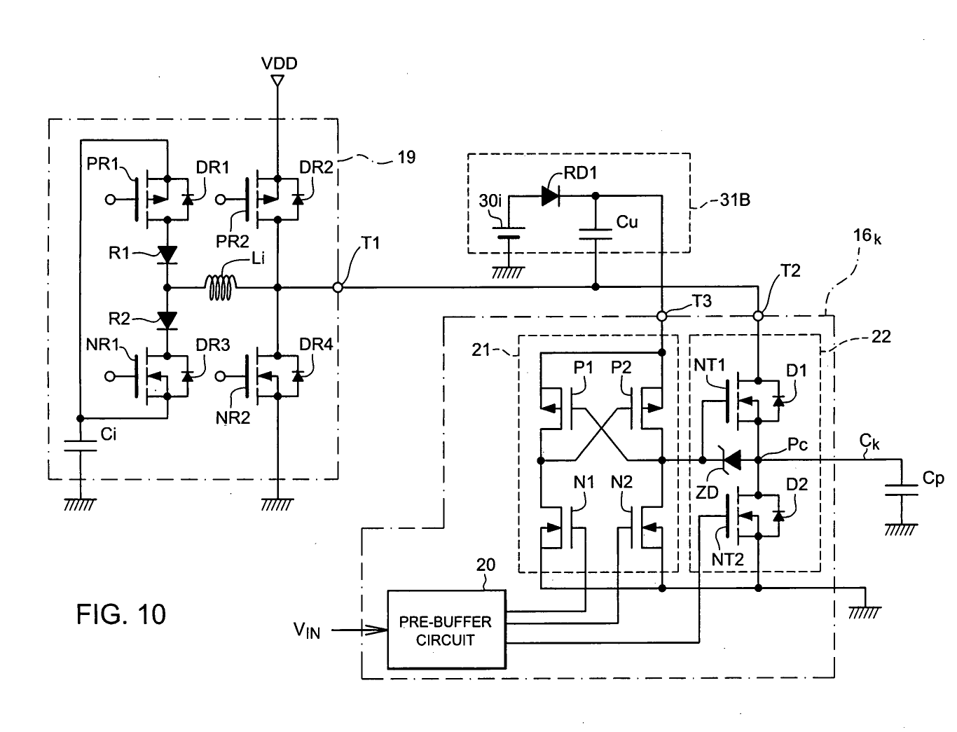

FIG. 10 schematically illustrates a configuration of a drive circuit according to a second embodiment of the present invention. Since identical elements in FIGS. 10 and 5 that are referred to by the same reference numerals have the same configuration and the same function, the detailed descriptions will be omitted. Except for a power supply circuit 31B, the drive circuit of the second embodiment has the same configuration as the drive circuit of the first embodiment (shown in FIG. 5).

With reference to FIG. 10, the power supply circuit 31B is a charge pump circuit that includes a power supply 30i, a diode RD1 having an anode connected to the power supply 30i, and a voltage-boosting capacitor Cu. One terminal of the voltage-boosting capacitor Cu is connected to the terminal T1 of the power recovery circuit 19 and to the terminal T2 of the output circuit 16ₖ, and the other terminal of the voltage-boosting capacitor Cu is connected to the cathode of the diode RD1 and to the terminal T3 of the output circuit 16ₖ.

When no driving pulse is applied to the capacitive load Cp (before time t0; FIG. 7), a gate voltage is supplied for turning on the n-channel type MOS transistor NR2 in the power recovery circuit 19 (FIG. 10). A ground potential is then applied to one terminal of the voltage-boosting capacitor Cu, and a power supply voltage Vi supplied by the power supply 30i is applied to the other terminal. A charging voltage Vi is set on the voltage-boosting capacitor Cu as a result. Then, when a driving pulse is applied to the capacitive load Cp (after time t0; FIG. 7), a power supply voltage Vp from the neutral capacitor Ci is applied to one terminal of the voltage-boosting capacitor Cu, through the p-channel type MOS transistor PR1, the diode R1, the inductor Li, and the terminal T1. As a result, the superimposed voltage (=Vi+Vp) obtained by superimposing the charging voltage Vi on the power supply voltage Vp is set on the voltage-boosting capacitor Cu. The superimposed voltage is applied to the p-channel type MOS transistors P1, P2 through the terminal T3.

In the power supply circuit 31B described above, a power supply voltage higher than the power supply voltage supplied by the power recovery circuit 19 can be applied to the level converting circuit 21. The high power supply voltage can be higher than the threshold voltage of the p-channel type MOS transistor P2, and can be set to a voltage that allows the n-channel type MOS transistor NT1 to be turned on without fail.

### 3. Third Embodiment

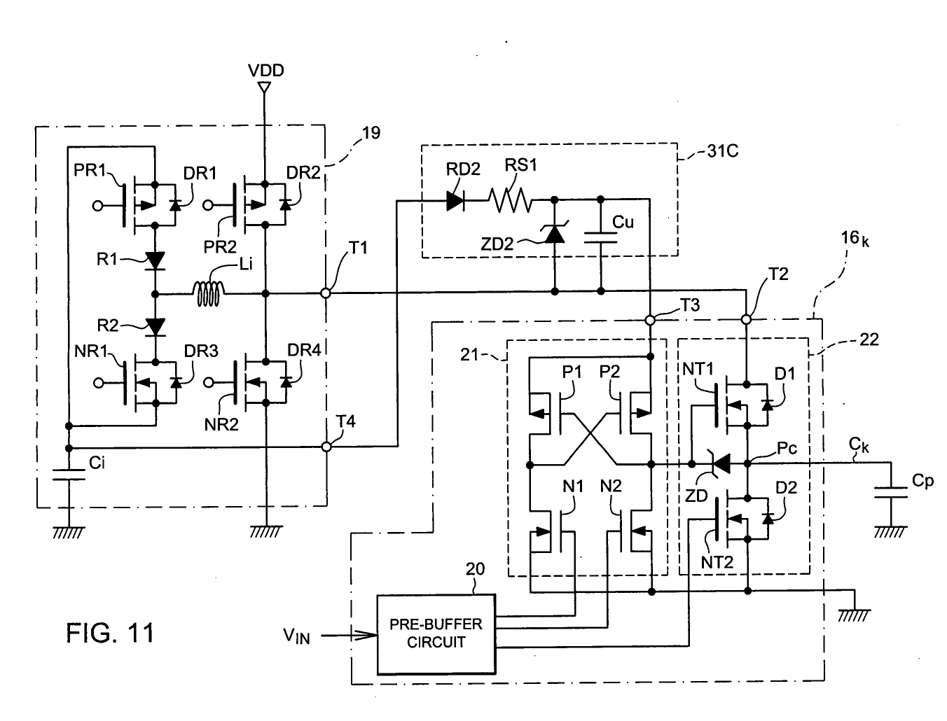

FIG. 11 schematically illustrates a configuration of a drive circuit according to a third embodiment of the present invention. Except for a power supply circuit 31C using the neutral capacitor Ci as a power supply, the drive circuit of the third embodiment has the same configuration as the drive circuit of the second embodiment (shown in FIG. 10). Since identical elements in FIGS. 11 and 10 that are referred to by the same reference numerals have the same configuration and the same function, the detailed descriptions will be omitted.

With reference to FIG. 11, the power supply circuit 31C is a charge pump circuit that includes a diode RD2, a resistor element RS1, a constant-voltage diode ZD2, and a voltage-boosting capacitor Cu. The anode of the diode RD2 is connected to one terminal of the neutral capacitor Ci through a terminal T4 of the power recovery circuit 19, and the cathode of the diode RD2 is connected to the resistor element RS1. The constant-voltage diode ZD2, composed of a Zener diode, for example, is connected in parallel to the voltage-boosting capacitor Cu. The constant-voltage diode ZD2 is capable of limiting the voltage on the voltage-boosting capacitor Cu to a constant voltage.

In the power supply circuit 31C described above, a power supply voltage higher than the power supply voltage supplied by the power recovery circuit 19 can be applied to the level converting circuit 21. The high power supply voltage can be higher than the threshold voltage of the p-channel type MOS transistor P2, and can be set to a voltage that allows the n-channel type MOS transistor NT1 to be turned on without fail.

Additionally, the power supply circuit 31C uses the neutral capacitor Ci of the power recovery circuit 19 as a power supply, thereby requiring no other power supply and thus affording a lower manufacturing cost than the power supply circuit 31B (FIG. 10) of the second embodiment.

### 4. Fourth Embodiment

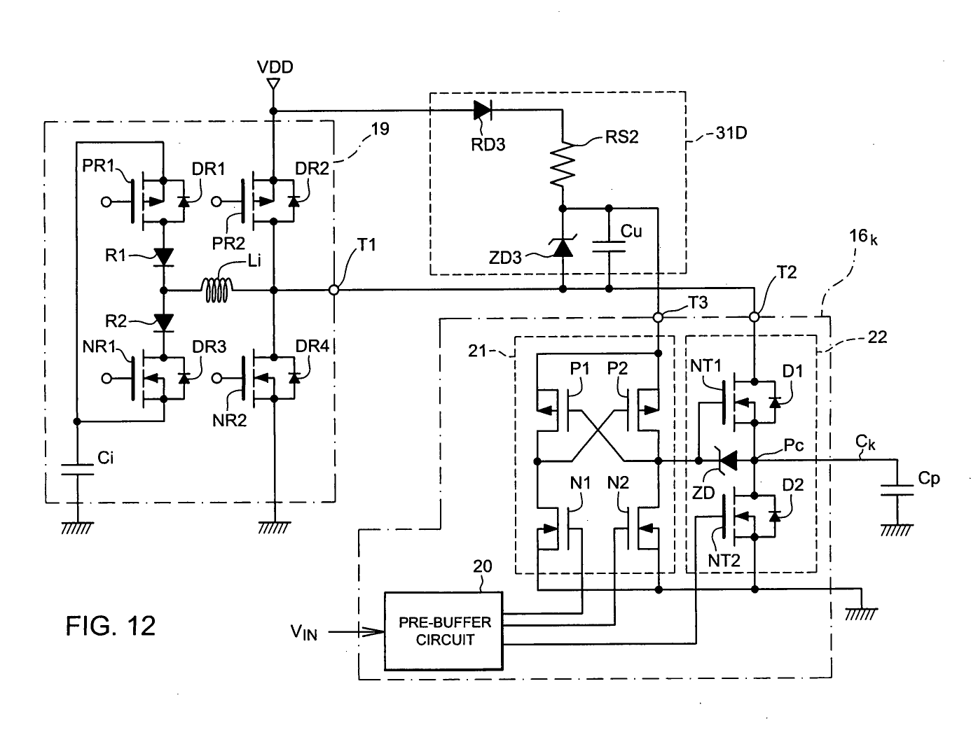

FIG. 12 schematically illustrates a configuration of a drive circuit according to a fourth embodiment of the present invention. Except for a power supply circuit 31D using a DC power supply for applying a power supply voltage VDD, the drive circuit of the fourth embodiment has the same configuration as the drive circuit of the second embodiment (shown in FIG. 10). Since identical elements in FIGS. 12 and 10 that are referred to by the same reference numerals have the same configuration and the same function, the detailed descriptions will be omitted.

With reference to FIG. 12, the power supply circuit 31D is a charge pump circuit that includes a diode RD3, a resistor element RS2, a constant-voltage diode ZD3, and a voltage-boosting capacitor Cu. The anode of the diode RD3 is connected to the DC power supply that applies a power supply voltage VDD, and the cathode of the diode RD3 is connected to the resistor element RS2. The constant-voltage diode ZD3, composed of a Zener diode, for example, is connected in parallel to the voltage-boosting capacitor Cu. The constant-voltage diode ZD3 is capable of limiting the voltage on the voltage-boosting capacitor Cu to a constant voltage.

In the power supply circuit 31D described above, a power supply voltage higher than the power supply voltage supplied by the power recovery circuit 19 can be applied to the level converting circuit 21. The high power supply voltage can be higher than the threshold voltage of the p-channel type MOS transistor P2, and can be set to a voltage that allows the n-channel type MOS transistor NT1 to be turned on without fail.

Additionally, the power supply circuit 31D uses the power supply voltage VDD that is used in the power recovery circuit 19, thereby requiring no other power supply and thus affording a lower manufacturing cost than the power supply circuit 31B (FIG. 10) of the second embodiment.

### 5. Fifth Embodiment

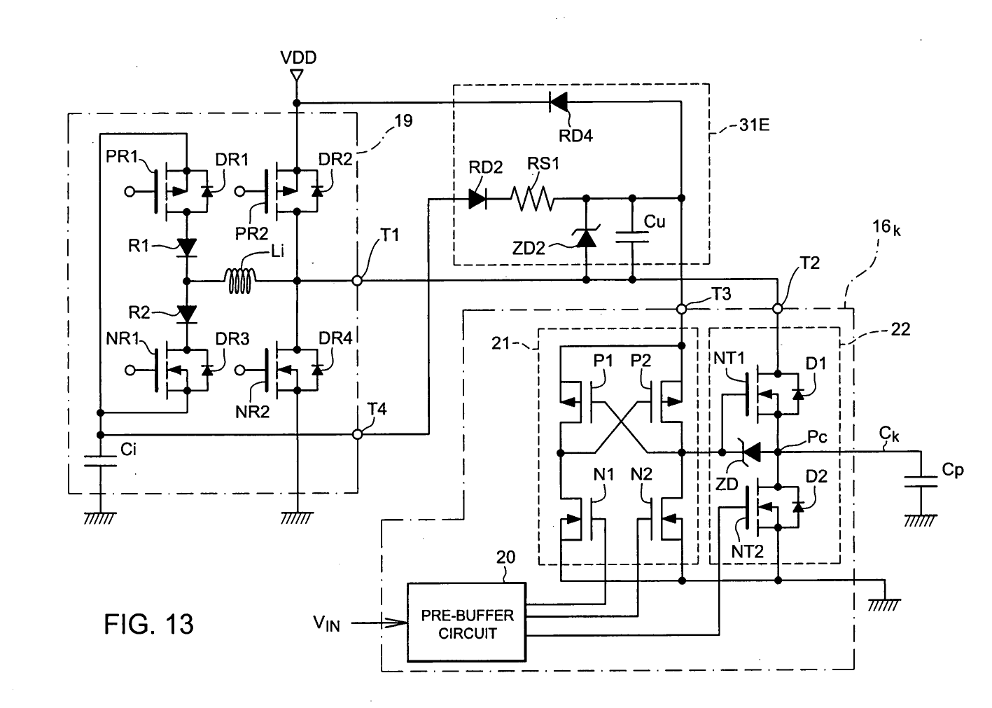

FIG. 13 schematically illustrates a configuration of a drive circuit according to a fifth embodiment of the present invention. Except for a power supply circuit 31E, the drive circuit of the fifth embodiment has the same configuration as the drive circuit of the second embodiment (shown in FIG. 10). The power supply circuit 31E uses both a DC power supply for supplying a power supply voltage VDD and the neutral capacitor Ci as voltage generators.

With reference to FIG. 13, the power supply circuit 31E includes a diode RD2, a resistor element RS1, a constant-voltage diode ZD2, and a voltage-boosting capacitor Cu which are the same constituent elements as the power supply circuit 31C (shown in FIG. 11). The power supply circuit 31E further includes a clamp diode RD4 connected to the I/O terminal T3 of the output circuit 16ₖ, the anode of the clamp diode RD4 being connected to the I/O terminal T3 and the cathode being connected to the DC power supply that supplies the power supply voltage VDD.

As described above, when no driving pulse is applied to the capacitive load Cp (before time t0; FIG. 7), a reference potential V_{SS} is applied to one terminal of the voltage-boosting capacitor Cu, and a power supply voltage from the neutral capacitor Ci is applied to the other terminal through the diode RD2 and the resistor element RS1. As a result, a charging voltage Vi that is limited by the constant-voltage diode ZD3 is set on the voltage-boosting capacitor Cu. Then, when a driving pulse is applied to the capacitive load Cp (after time t0; FIG. 7), while the power supply voltage applied to one terminal of the voltage-boosting capacitor Cu rises from the reference potential V_{SS}, a superimposed voltage Vcp obtained by superimposing the charging voltage Vi on the rising power supply voltage is set on the the voltage-boosting capacitor Cu. The superimposed voltage Vcp is applied to the level converting circuit 21 through the terminal T3.

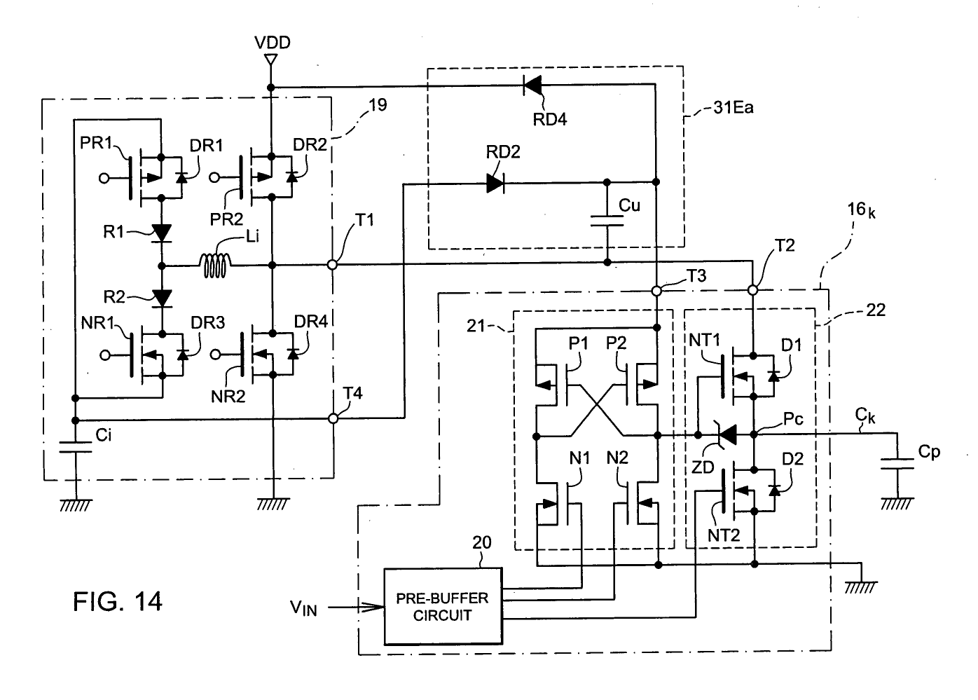

Before the superimposed voltage Vcp exceeds the power supply voltage VDD, a forward bias can be applied to the clamp diode RD4 so that the superimposed voltage Vcp is clamped to the power supply voltage VDD. As a result, the voltage Vcp supplied to the level converting circuit 21 is limited to a voltage equal to or lower than the power supply voltage VDD, thus preventing an overvoltage exceeding the voltage capability of the level converting circuit 21 from being applied to the level converting circuit 21. FIG. 14 illustrates a configuration of a power supply circuit 31Ea that is a modification of the power supply circuit 31E. This power supply circuit 31Ea has the configuration of the power supply circuit 31E (FIG. 13) without only the constant-voltage diode ZD2 and the resistor element RS1.

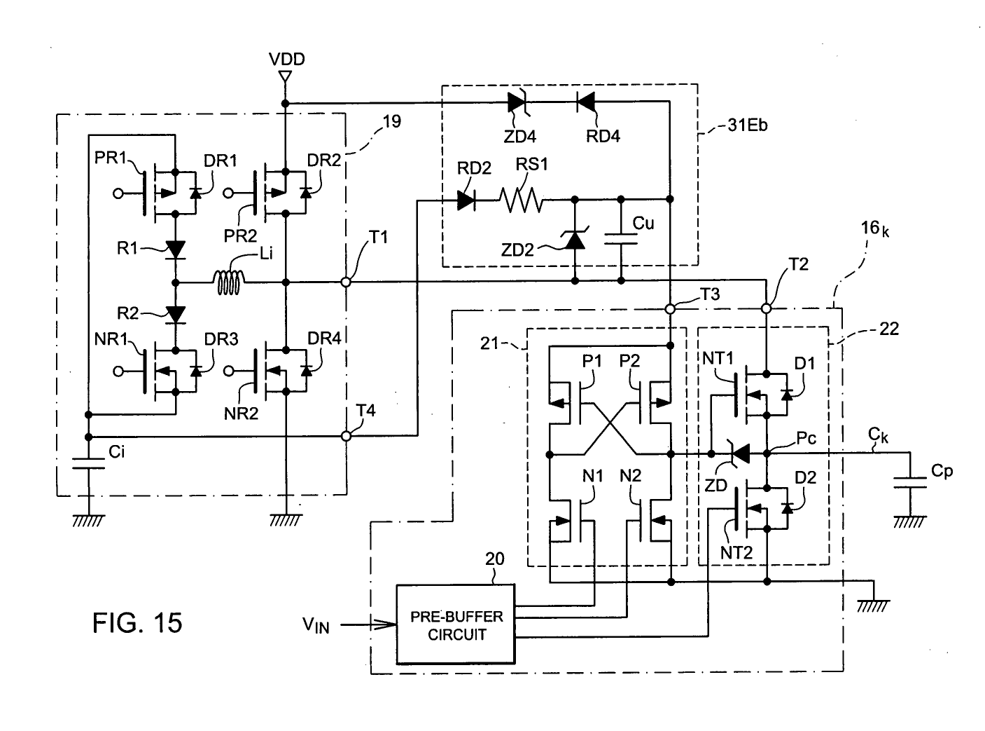

Further, FIG. 15 illustrates a configuration of a power supply circuit 31Eb that is a modification of the power supply circuit 31E. This power supply circuit 31Eb has the configuration of the power supply circuit 31E (FIG. 13) and further has a constant-voltage diode ZD4 series-connected between the clamp diode RD4 and a power supply that applies a power supply voltage VDD. The anode of the constant-voltage diode ZD4, composed of a Zener diode, for example, is connected to a DC power supply that supplies a power supply voltage VDD, and the cathode is connected to the cathode of the clamp diode RD4. The constant-voltage diode ZD4 allows fine adjustment in the range of the voltage Vcp supplied to the level converting circuit 21.

### 6. Sixth Embodiment

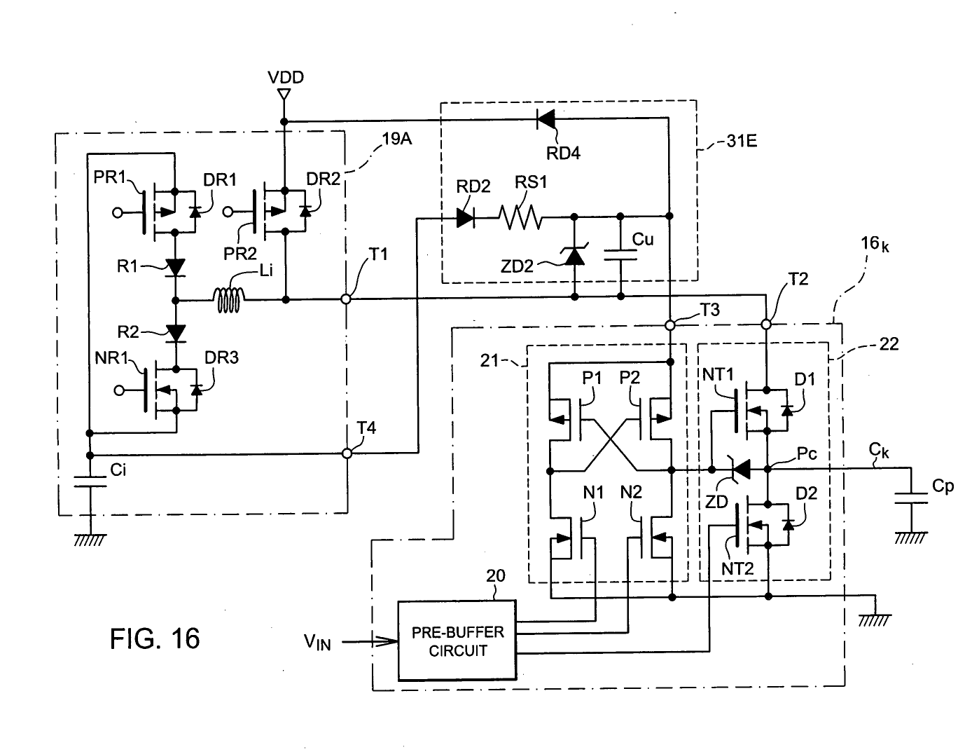

In the first to fifth embodiments described above, the same type of power recovery circuit 19 is used, no limitation thereto intended. FIGS. 16, 17 and 18 illustrate examples of drive circuits using other power recovery circuits 19A, 19B and 19C according to a sixth embodiment of the present invention. In the sixth embodiment, the power supply circuit 31E (FIG. 13) of the fifth embodiment is used as the power supply circuit that supplies a power supply voltage to the level converting circuit 21, no limitation thereto intended. Power supply circuits of other examples may be used herein instead of the power supply circuit 31E of the fifth embodiment.

With reference to FIG. 16, the power recovery circuit 19A has the configuration of the power recovery circuit 19 (FIG. 5) without the n-channel type MOS transistor NR2. The operation of the power recovery circuit 19A is the same as that of the power recovery circuit 19 of the first embodiment when the n-channel type MOS transistor NR2 is always turned off.

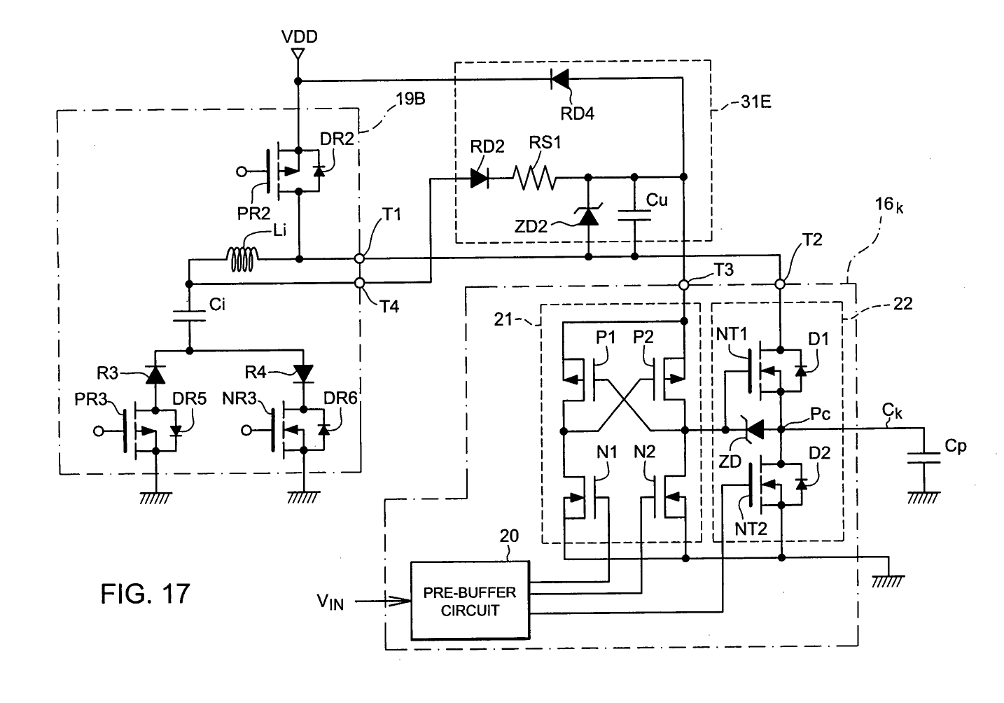

With reference to FIG. 17, the power recovery circuit 19B comprises a p-channel type MOS transistor PR2, an inductor Li and a neutral capacitor Ci that are connected in series. One terminal of the neutral capacitor Ci is connected to a p-channel type MOS transistor PR3 through a diode R3 and to an n-channel type MOS transistor NR3 through a diode R4. When no driving pulse is applied to the capacitive load Cp, a gate voltage is applied so as to turn off all the MOS transistors PR3, NR3 and PR2 in the power recovery circuit 19B.

When the output voltage applied to the capacitive load Cp is allowed to rise, a gate voltage is applied to turn on the p-channel type MOS transistor PR3 in the power recovery circuit 19B. Meanwhile, the n-channel type MOS transistor NT1 on the high-voltage side of the totem-pole circuit 22 is turned on. Through the operation of an LC resonant circuit formed by the capacitive load Cp and the inductor Li of the power recovery circuit 19B, driving current from the neutral capacitor Ci is supplied to the capacitive load Cp through the inductor Li, the terminals T1, T2 and the n-channel type MOS transistor NT1, thereby allowing the level of the output voltage to start to rise from the reference potential V_{SS}. A gate voltage is then applied to turn on the p-channel type MOS transistor PR2, thereby causing the output voltage to be clamped to the power supply voltage VDD.

When the output voltage applied to the capacitive load Cp is allowed to drop, a gate voltage is applied to turn the p-channel type MOS transistors PR2, PR3 from on to off in the power recovery circuit 19B. Further, a gate voltage is applied to turn on the n-channel type MOS transistor NR3. As a result, electrical charges accumulated in the charged capacitive load Cp is recovered into the neutral capacitor Ci through the n-channel type MOS transistor NT1, the terminals T2, T1 and the inductor Li. The recovery causes the capacitive load Cp to be discharged, thus causing the output voltage level to start to drop from the power supply voltage VDD.

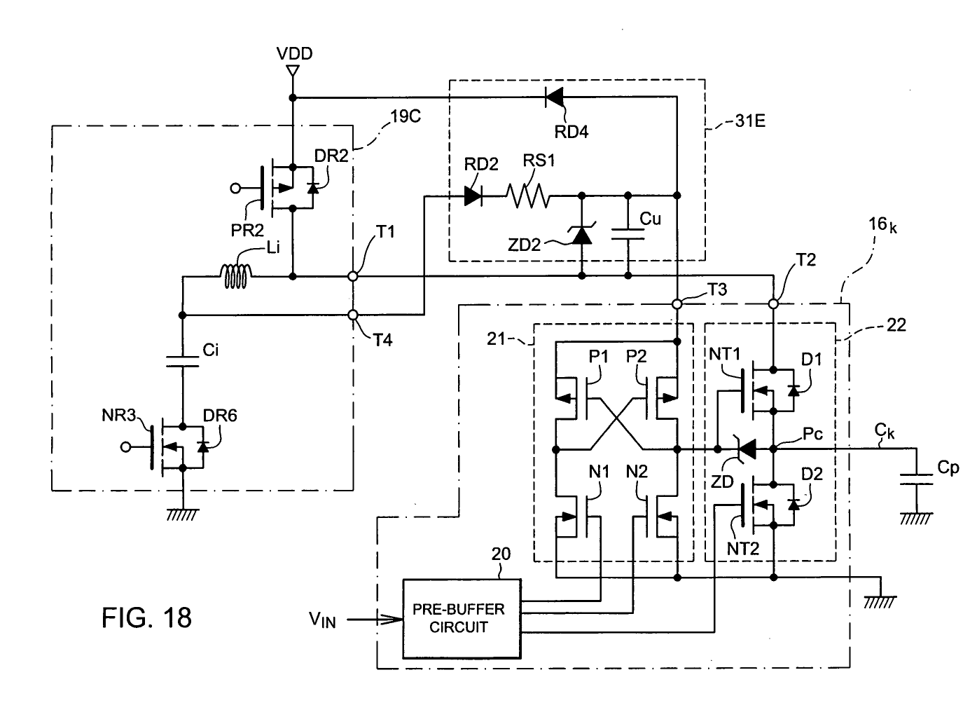

The power recovery circuit 19C illustrated in FIG. 18 has substantially the same configuration as the power recovery circuit 19B (shown in FIG. 17) without the p-channel type MOS transistor PR3. The operation of the power recovery circuit 19C is the same as that of the operation of the power recovery circuit 19B when the p-channel type MOS transistor PR3 is always turned off.

### 7. Seventh Embodiment

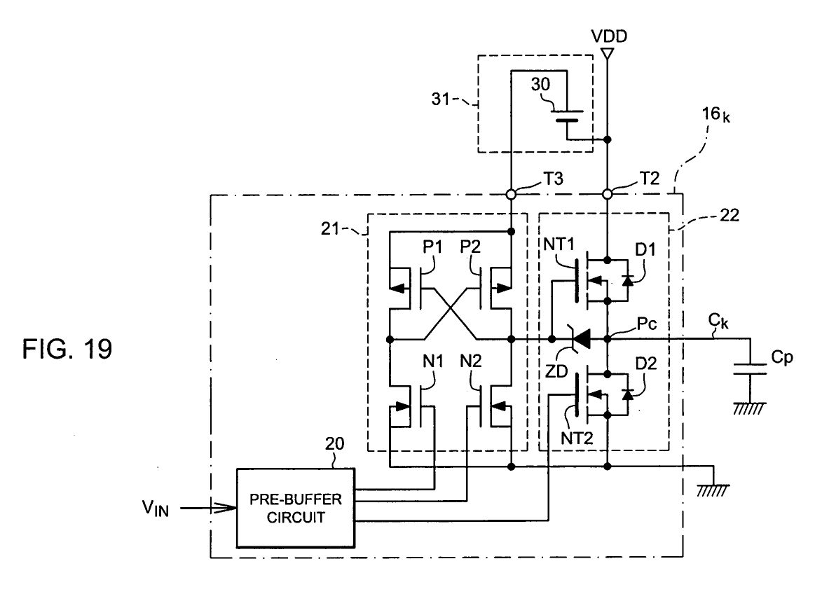

In all the first to sixth embodiments described above, the output circuit 16ₖ uses a power recovery circuit as a power supply circuit. Alternatively, the output circuit 16ₖ may use no power recovery circuit. FIG. 19 is a diagram illustrating a configuration of a drive circuit according to a seventh embodiment of the present invention. In FIG. 19, the output circuit 16ₖ uses a DC power supply.

With reference to FIG. 19, the power supply voltage VDD supplied from the DC power supply is applied to a totem-pole circuit 22 through a terminal T1. The drive circuit of FIG. 19 comprises a power supply circuit 31 that generates a voltage higher than the power supply voltage VDD. The power supply circuit 31 comprises a power supply 30 that boosts the power supply voltage VDD and supplies the boosted voltage to the sources of p-channel type MOS transistors P1, P2 of a level converting circuit 21 through a terminal T3. The power supply circuit 31B (FIG. 10) may be used instead of the power supply circuit 31.

In the foregoing, the first to seventh embodiments have been described. Some elements of the drive circuits illustrated in FIGS. 5 and 9 through 19 of the embodiments are contained within the column electrode driver 13, no limitation thereto intended. The some elements of the drive circuits of FIGS. 5 and 9 through 19 may be contained within the first row electrode driver 17A as a scanning pulse generator circuit or a sustaining discharge pulse generator circuit.

The power supply circuits 31, 31B, 31C, 31D, 31E, 31Ea, and 31Eb of the above embodiments are separated from the column electrode driver 13 as illustrated in FIG. 4, no limitation thereto intended. Some elements of the drive circuits, such as for example, diodes, resistor elements and/or capacitors, may be contained within the column electrode driver 13.

This application is based on Japanese Patent Application No. 2005-226275 which is hereby incorporated by reference.

What is claimed is:

1. A drive circuit for supplying output voltages to a plurality of capacitive loads in response to input logic signals, the output voltages depending on a first power supply voltage from an output terminal of a first power supply circuit, said drive circuit comprising:
a plurality of switching circuits each including a first switching transistor arranged on a high-voltage side thereof and a second switching transistor arranged on a low-voltage side thereof, said first switching transistor and said second switching transistor being connected in series, and a connection point between said first switching transistor and said second switching transistor being connected to a corresponding one of said capacitive loads;
a second power supply circuit for supplying a second power supply voltage; and
a plurality of output control circuits, each of the output control circuits, in response to a corresponding one of the input logic signals, supplying a first switching control signal depending on the second power supply voltage to said first switching transistor, and supplying a second switching control signal to said second switching transistor, thereby to individually control switching operations of said first switching transistor and said second switching transistor, wherein:
said second power supply circuit superimposes a DC voltage on the first power supply voltage to generate the second power supply voltage; and
said first switching transistor selectively supplies an output voltage to said corresponding one of said capacitive loads through said connection point in response to the first switching control signal.

2. The drive circuit according to claim 1, wherein said second power supply circuit generates, as the second power supply voltage, a voltage that turns on said first switching transistor.

3. The drive circuit according to claim 2, wherein:
each of said plurality of output control circuits includes a p-channel type switching transistor for selectively supplying the first switching control signal to said first switching transistor; and
said second power supply circuit supplies the second power supply voltage that is equal to or higher than a threshold voltage of said p-channel type switching transistor.

4. The drive circuit according to claim 2, wherein:
each of said plurality of output control circuits includes a third switching transistor arranged on a high-voltage side thereof and a fourth switching transistor arranged on a low-voltage side thereof, said third switching transistor and said fourth switching transistor being connected in series, and the first switching control signal being applied to said first switching transistor from a connection point between said third switching transistor and said fourth switching transistor; and
said second power supply circuit supplies the second power supply voltage that is equal to or higher than a threshold voltage of said third switching transistor.

5. The drive circuit according to claim 2, wherein said second power supply circuit includes a voltage-boosting capacitor, one terminal of said voltage-boosting capacitor being connected to an output terminal of said first power supply circuit, and the other terminal of said voltage-boosting capacitor being connected to both a predetermined voltage supply and said plurality of output control circuits.

6. The drive circuit according to claim 5, wherein said second power supply circuit further includes a constant-voltage diode connected in parallel to said voltage-boosting capacitor, an anode of said constant-voltage diode being connected to said one terminal of said voltage-boosting capacitor, and a cathode of said constant-voltage diode being connected to the other terminal of said voltage-boosting capacitor.

7. The drive circuit according to claim 5, wherein said first power supply circuit includes a power recovery circuit having:
an inductor in combination with said capacitive loads for forming a resonant circuit;
at least one switching device for supplying to said switching circuit the first power supply voltage that is a DC voltage supplied from a DC power supply; and
a neutral capacitor for accumulating electrical charges recovered from said capacitive loads or electrical charges to be supplied to said capacitive loads when said capacitive loads are charged or discharged, wherein said predetermined voltage supply includes said neutral capacitor.

8. The drive circuit according to claim 5, wherein said first power supply circuit includes a power recovery circuit having:
an inductor in combination with said capacitive loads for forming a resonant circuit;
at least one switching device for supplying to said switching circuit the first power supply voltage that is a DC voltage supplied from a DC power supply; and
a neutral capacitor for accumulating electrical charges recovered from said capacitive loads or electrical charges to be supplied to said capacitive loads when said capacitive loads are charged and discharged, wherein said predetermined voltage supply includes said DC power supply.

9. The drive circuit according to claim 8, wherein said second power supply circuit further includes a clamp diode connected between said DC power supply and the other terminal of said voltage-boosting capacitor, an anode of said clamp diode being connected to the other terminal of said voltage-boosting capacitor, and a cathode of said clamp diode being connected to said DC power supply.

10. The drive circuit according to claim 9, wherein said second power supply circuit further includes a constant-voltage diode connected between said clamp diode and said DC power supply, an anode of said constant-voltage diode being connected to said DC power supply, and a cathode of said constant-voltage diode being connected to said cathode of said clamp diode.

11. The drive circuit according to claim 5, wherein said first power supply circuit includes a power recovery circuit having:
an inductor in combination with said capacitive loads for forming a resonant circuit;
at least one switching device for supplying to said switching circuit the first power supply voltage that is a DC voltage supplied from a DC power supply; and
a neutral capacitor for accumulating electrical charges recovered from said capacitive loads or electrical charges to be supplied to said capacitive loads when said capacitive loads are charged or discharged, wherein said predetermined voltage supply includes both said DC power supply and said neutral capacitor.

12. The drive circuit according to claim 11, wherein said second power supply circuit further includes a clamp diode connected between said DC power supply and the other terminal of said voltage-boosting capacitor, an anode of said clamp diode being connected to the other terminal of said voltage-boosting capacitor, and a cathode of said clamp diode being connected to said DC power supply.

13. The drive circuit according to claim 12, wherein said second power supply circuit further includes a constant-voltage diode connected between said clamp diode and said DC power supply, an anode of said constant-voltage diode being connected to said DC power supply, and a cathode of said constant-voltage diode being connected to said cathode of said clamp diode.

14. The drive circuit according to claim 1, wherein each of said switching circuits has a totem-pole structure in which two n-channel type switching transistors are connected in series as said first and second switching transistors.

15. The drive circuit according to claim 14, wherein said first and second switching transistors are comprised of MOS field effect transistors.

16. The drive circuit according to claim 1, wherein each of said switching circuits has a push-pull structure in which two switching transistors of different conductivity types are connected in series as said first and second switching transistors.

17. The drive circuit according to claim 16,-wherein said first switching transistor is comprised of a p-channel type MOS field effect transistor, and said second switching transistor is comprised of an n-channel type MOS field effect transistor.

18. The drive circuit according to claim 1, wherein said first power supply circuit supplies, to said switching circuit, the first power supply voltage that is a DC voltage.

19. The drive circuit according to claim 1, wherein said capacitive loads are a plurality of display cells arranged as a two-dimensional array.

20. A display apparatus comprising: a plurality of display cells arranged as a two-dimensional array; a plurality of electrodes connected to said plurality of display cells; and a drive circuit for supplying output voltages to a plurality of capacitive loads through said plurality of electrodes in response to input logic signals, the output voltages depending on a first power supply voltage from an output terminal of a first power supply circuit,
said drive circuit including:
a plurality of switching circuits each including a first switching transistor arranged on a high-voltage side thereof and a second switching transistor arranged on a low-voltage side thereof, said first switching transistor and said second switching transistor being connected in series, and a connection point between said first switching transistor and said second switching transistor being connected to a corresponding one of said capacitive loads;
a second power supply circuit for supplying a second power supply voltage; and
a plurality of output control circuits, each of the output control circuits, in response to a corresponding one of the input logic signals, supplying a first switching control signal depending on the second power supply voltage to said first switching transistor, and supplying a second switching control signal to said second switching transistor, thereby to individually control switching operations of said first switching transistor and said second switching transistor, wherein:
said second power supply circuit superimposes a DC voltage on the first power supply voltage to generate the second power supply voltage; and
said first switching transistor selectively supplies an output voltage to said corresponding one of said capacitive loads through said connection point in response to the first switching control signal.
